(19) United States
(12) Patent Application Publication
(10) Pub. No.: US 2022/0105382 A1
(43) Pub. Date: Apr. 7, 2022

(54) EXERCISE WEIGHT SYSTEM AND METHOD OF MANUFACTURING EXERCISE WEIGHTS

(71) Applicant: PALÁCIO INTERNATIONAL HOLDINGS, LLC, Raleigh, NC (US)

(72) Inventor: John AMBIELLI, Jacksonville, FL (US)

(73) Assignee: PALÁCIO INTERNATIONAL HOLDINGS, LLC, Raleigh, NC (US)

(21) Appl. No.: 17/495,496

(22) Filed: Oct. 6, 2021

Related U.S. Application Data
(60) Provisional application No. 63/088,191, filed on Oct. 6, 2020.
(60) Provisional application No. 63/088,202, filed on Oct. 6, 2020.
(60) Provisional application No. 63/088,212, filed on Oct. 6, 2020.

(51) Int. Cl. A63B 21/072; A63B 21/06; A63B 21/075; B28D 1/22; A63B 71/00; B65D 25/10

(52) U.S. Cl. CPC A63B 21/0726; A63B 21/0604; A63B 21/075; B28D 7/005; A63B 71/0036; B65D 25/108; B28D 1/22

(57) ABSTRACT

A method of manufacturing exercise weights from natural stone material that includes steps of cutting a natural stone, assembling a handlebar and a weight plate, and sliding a locking device or a collar onto the handlebar. The natural stone material may include granite, marble, quartzite, rocks, schist, engineered stone quartz, glass, or amalgams of concrete with glass or granite or marble. The handlebar is designed to hold one or more weight plates with a collar locking system.

This application claims priority to U.S. provisional patent application No. 63/088,191 filed on Oct. 6, 2020, U.S. provisional patent application No. 63/088,202 filed on Oct. 6, 2020, and U.S. provisional patent application No. 63/088,212 filed on Oct. 6, 2020. The disclosures of these prior applications are hereby incorporated herein in their entirety.

### TECHNICAL FIELD OF THE DISCLOSURE

The present disclosure relates to the field of exercise equipment for strength training, and, more specifically, to exercise weights, methods of manufacturing exercise weights, and a storage device to store exercise weights. More particularly, the present disclosure relates to an exercise weight manufactured from natural stone material and a method of manufacturing the exercise weight of natural stone.

### BACKGROUND OF THE DISCLOSURE

Fitness training with conventional exercise weight equipment, such as metal dumbbells, kettlebells, and barbells with accompanying weight plates has increased in popularity in recent years for both professional and amateur athletes. However, the conventional exercise weight exercise equipment is often beset by a myriad of disadvantages or shortcomings.

For example, the conventional metal exercise equipment is manufactured using steel or iron for the weight plates, which involves a time consuming and labor intensive multistep manufacturing processes. The manufacturing processes involve casting a metal material into the shape of a weight plate or machining a weight plate from a bar or block of the metal material. The conventional processes may also include coloring the formed metal material for a better appearance. Often, the conventional manufacturing process further includes applying a rubber coating to the formed weight plates for protection of the material from chipping, cracking, or other damage during use. The rubber coating also has aesthetic functions.

Another significant disadvantage of the conventional manufacturing process of metal exercise equipment is the toxic waste and the negative environmental impact. Conventional weight plates or similar exercise equipment is manufacturing by casting iron or steel, which is then machined into a desired final form and shape. However, casting and machining iron and steel releases heavy metals into the air and atmosphere. These conventional methods also are heavily energy dependent. The conventional manufacturing processes pose significant dangers to humans, such as breathing in cristobalite (silicosis hazard), dermatitis from repeated skin contact with investment, debubblizers, fluxes etc., breathing in metal fumes, damage to the eyes by from projectiles of chunks of material ejected during machining of the casted iron or steel, and damaging light emissions during the machining process, and burns from the electrical, gas, and mechanical equipment used for casting.

Additionally, conventional exercise equipment may be hazardous for users due to the possibility of an allergic reaction to latex or the health risks associated with a sensitivity to strong odors or toxins released by the materials used in conventional exercise equipment as discussed above.

Recently, many manufacturers have started using alternative materials, such as marble and stone as an alternative to steel and iron. However, these alternatives still pose significant disadvantages. For example, the improper selection of stones may result in weakened or brittle equipment, or inaccurate weights of the exercise equipment over time, and poor construction of stone plates used with metal bars can lead to dangerous instability in the exercise equipment, which causes unhealthy muscle fatigue and/or injuries.

### SUMMARY OF THE DISCLOSURE

Accordingly, there is a need for a method of manufacturing exercise weights using efficient, safe, and environmentally conscious manufacturing processes. There is also a need for an improved locking mechanisms to secure the weight plates to handles and/or barbells and the like, which is fast and easy to mount/dismount and lock while also safely securing the weight plates during use.

An aspect of the disclosure provides a method for manufacturing fixed or variable load exercise weights including, without limitation, dumbbells, kettlebells, and barbells using natural stone material. The method of manufacturing comprises steps of cutting a natural stone to form at least one weight plate, assembling the at least one weight plate to a handle bar, and securing the at least one weight plate to the handle bar by sliding a locking device or a collar onto the handle bar. The natural stone material of the weight plate includes, without limitation, granite, marble, quartzite, rocks, schist, engineered stone—quartz, glass, or amalgams of concrete with glass or granite or marble and the like.

According to another embodiment, a handlebar is provided, which may be a dumbbell, barbell, or the like, configured to be attached to one or more dumbbell plates or barbell plates and secured by a collar locking system. The collar locking system is designed to securely hold one or more weight plates to present the weight plates from sliding down or off of the handlebar while in use. The collar locking system includes a collar configured to slide on to the handlebar and secure at a one of a plurality of positions on the handlebar

In yet another embodiment, a storage device is provided to hold and store a plurality of exercise weights, which includes the manufactured weight plates, a handlebar, and a collar of the collar locking system. The storage device may be made from multiple types of material, such as a solid or laminated slab of wood material, a natural stone material, a metal material, a plastic polymer or composite, or a combination of thereof. The storage device is formed of a substrate or planar board that includes a plurality of slots that are machined to with a set diameter and thickness that corresponds to weight and/or other exercise equipment. This storage device can be mounted on a piece of furniture or a table. The storage device is also configured to include slots or depressions to hold the handlebar, either alone or in an assembled form with the weight plates, and the collar(s).

These and other aspects, advantages and novel features of the disclosure will become more apparent from the following detailed description of the disclosure when considered in conjunction with the accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiment(s), and explain various principles and advantages of those embodiments.

FIG. 1 is a flowchart illustrating a method of manufacturing a fixed or variable load exercise weight from a natural stone material in accordance with one or more embodiments.

FIG. 2 is an exploded view of an assembled exercise weight according to one or more embodiments.

FIG. 3 is a perspective view of a storage device according to one or more embodiments.

FIG. 4A is a side view of an assembled exercise weight according to one or more embodiments.

FIG. 4B is a cross-sectional view a locking device or collar assembled on a handlebar in a locked position according to one or more embodiments.

FIG. 4C is a cross-sectional view a locking device or collar assembled on a handlebar in an unlocked position according to one or more embodiments.

FIG. 5A is a perspective view of a handlebar according to one or more embodiments.

FIG. 5B is a cross-sectional view of the handlebar along line B-B of FIG. 5A according to one or more embodiments.

FIG. 5C is a cross-sectional view of the handlebar with the locking device or collar along line C-C of FIG. 5A according to one or more embodiments.

FIG. 5D is a cross-sectional view of the handlebar with the locking device or collar along line D-D of FIG. 5A according to one or more embodiments.

FIG. 5E is a cross-sectional view of the handlebar along line A-A of FIG. 5A according to one or more embodiments.

FIG. 6 is a perspective view of a handlebar with a locking device or collar assembled on the handlebar according to one or more embodiments.

FIG. 7 is another perspective view of a handlebar according to one or more embodiments.

FIG. 8 is a perspective view of a locking device or collar according to one or more embodiments.

FIG. 9 is a perspective view of an assembled exercise weight according to one or more embodiments.

FIG. 10 is a perspective view of a storage device with weight plates, locking devices or collars, and handlebars positioned on the storage device according to one or more embodiments.

FIG. 11 is a perspective view of a storage device with assembled exercise weights positioned on the storage device according to one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The device and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION OF THE DISCLOSURE

A method of manufacturing will be described. The method includes steps or processes for manufacturing a fixed or variable load exercise weight plate from a natural stone material. Steps of the method include positioning a natural stone material relative to a stone cutting tool, such as a water jet cutting machine, stone-cutting drill tool, or the like. Upon positioning the natural stone material, the natural stone material is cut into a plurality of weight plates. The plurality of weight plates may be of any particular shape, size, and thickness suitable for use as exercise equipment, and each weight plate has a hole cut in a center of the weight plate. The hole having an inner diameter that corresponds to an outer diameter of a handlebar, with a sufficient tolerance to allow the handlebar to be inserted into the hole. The method further includes assembling the handlebar and the plurality of weight plates by inserting the handlebar into the hole of one or more of the plurality of weight plates, and then sliding a locking device or a collar onto the handlebar after inserting the handlebar into the hole of the weight plates to secure the weight plates onto the handlebar. The plurality of weight plates are designed to be assembled onto each end of the handlebar.

The natural stone material used to manufacture the weight plates includes, without limitation, granite, marble, quartzite, rocks, schist, engineered stone—quartz, glass, amalgams of concrete with glass or granite or marble and the like, sodalite, calcite, crystal, travertine, soapstone, limestone, and/or slate.

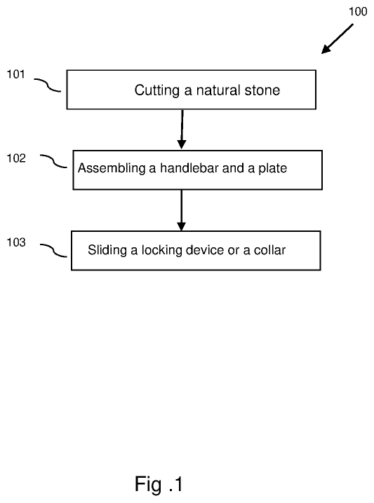

FIG. 1 is a flowchart illustrating a method 100 of manufacturing a fixed or variable load exercise weight from a natural stone material in accordance with one or more embodiments. As illustrated, the method 100 includes a step 101 of positioning a stone material relative to a cutting tool or machine, and cutting a stone material to form weight plates to be used in the dumbbells and/or barbells and the like. The stone material may be positioned in any orientation or configuration to facilitate cutting of the stone material by the cutting tool or machine into the desired shape/dimensions.

The natural stone material includes, without limitation, granite, dolomite, onyx, agate, marble, quartzite, rocks, schist, engineered stone—quartz, glass, amalgams of concrete with glass or granite or marble, sodalite, calcite, crystal, travertine, soapstone, limestone, and/or slate. The stone material may be in a wide variety of colors and patterns, which allows the manufacturer to offer a wide range of options for a user. These examples are not intended to limit the color and/or pattern of the material of the natural stone.

The step 101 includes cutting the positioned stone material by using the cutting tool/machine to cut the stone material to have a particular diameter or width and a particular thickness. The dimensions of each weight plate may be selected based on the desired weight of the formed weight plate. The type of material of the natural stone may affect the dimensions of the weight plate to achieve the desired weight of the weight plate. For example, a particular diameter and thickness may be selected to result in weight plates having a weight of 1 lb, 2.5 lbs, 5 lbs, 10 lbs, 25 lbs, 35 lbs, 45 lbs, or 55 lbs. These are merely examples of weights of the weight plates. A skilled artisan will understand that any weight may be selected and formed by cutting the stone material to corresponding dimensions. In particular, the stone material may cut into any thickness of the weight plate, such as a thickness of 0.5-6 inches, or more particularly, a thickness of 1-3 inches.

The outer shape of the weight plate may be any particular shape. For example, the outer shape of the weight plate may be, without limitation, circular or one of several geometric shapes including, without limitation, oval, square, pentagon, hexagon, octagon, nonagon, decagon, hendecagon, dodecagon, tridecagon, tetradecagon, and the like. A skilled artisan will understand that the outer shape of each weight plate may be cut into any suitable shape, and the above examples are for illustrative purposes only, which are not intended to limit the scope of the disclosure.

The cutting of the stone material may be carried out using any suitable tool or machine that is capable of cutting the stone material. For example, the cutting process of step 101 may be performed by a water-jet cutting tool, a cutting drill tool, or a computer-controlled stone cutting machine.

In step 101, the cutting process also includes cutting a center hole in or near the center of each weight plate using the same cutting tool/machine or a different cutting tool machine, which may be a water jet machine or one of several stone-cutting drill bits. The center hole is cut to have a corresponding shape as a shape of a handlebar, which allows the weight plates to be removably attached to the handlebar. The center hole is also cut to have a diameter substantially equal to or larger than an outer diameter of the handlebar. For example, the diameter of the center hole may be cut to be equal to or less than 2 inches larger than the outer diameter of the handlebar, and more particular, equal to or less than 1 inch larger than the outer diameter of the handlebar. However, a skilled artisan will understand that the diameter of the center hole may be cut to any diameter or width suitable for allowing insertion of the handlebar into the center hole.

The center hole may further include a liner that is press-fitted or otherwise tightly fitted into the center hole to serve as a protector of the stone material from abrasion and/or chipping. The liner may cover a partial or the entire portion of the inner surface of the center hole, and may also cover a partial or entire portion of a surrounding edge of the center hole. The shape and size of the liner can be varied depending on the size of the center hole and the corresponding size of the handlebar, such that the inner diameter of the liner forms a hole that has a diameter or width to allow the handlebar to be inserted into the hole of the liner. The liner may be formed of any suitable material, such as metal, stone, plastic, wood, or the like. For example, an exemplary embodiment may have a metal liner inserted into the center hole of the weight plate to cover an entire inner surface of the center hole as well as an edge of the center hole. The metal liner provides protection of the stone material from chipping or other damage that may be caused when inserting the handlebar into the center hole and/or during use of the dumbbell, barbell, etc.

The liner may also have a patterned/grooved inner surface or a smooth surface. For example, a smooth inner surface may facilitate easier sliding of the weight plate onto the handlebar. Alternatively, a patterned or grooved inner surface may facilitate increased friction with the handlebar, which may aid in securing the weight plate to the handlebar and/or reduce rotation of the weight plate around the handlebar during use.

At step 102, the finished weight plates are assembled onto the handlebar. One or more weight plates are added to the handlebar by inserting a respective side of the handlebar into the center hole of the weight plate. The handlebar, which is described in more detail below, includes a center portion and two end portions located on each side of the center portion. Each center portion is divided from the center portion by a stopping member, which may be in the form of a circumferential protrusion or outer ring extending outward from the handlebar, or the like. The structure of the stopping member may be in any other configuration that functions to stop a weight plate inserted onto the end portion of the handlebar from sliding onto the center portion of the handlebar.

The handlebar may be manufactured of any suitable material including, without limitation, metal, natural stone, plastic, or wood. In addition, the different portions of the handlebar may be formed of different materials, such that the handlebar is formed of a combination of metal, natural stone, plastic, wood, or the like.

At step 103, a locking device or collar is attached to the handlebar in order to secure the weight plates previously slide onto the end portions of the handlebar. The locking device, which will be described in more detail below, is in the form of a ring shape with an opening in a central portion along an axial direction that receives one end portion of the handlebar.

At step 103, the locking device is attached by sliding the locking device over one end portion of the handlebar once the plates are in position on the end portion of the handlebar. The end portion is inserted into the central opening such that the locking device surrounds the end portion of the handlebar in a circumferential direction. The locking device is slid along the end portion into a locking position, which may be a position in which the locking device is in contact with an outermost weight plate on the end portion. The locking device is locked to the end portion of the handlebar to hold the weight plate(s) from sliding or otherwise moving off of the handlebar for safety during use. The process and structure for locking the locking device will be described in detail below.

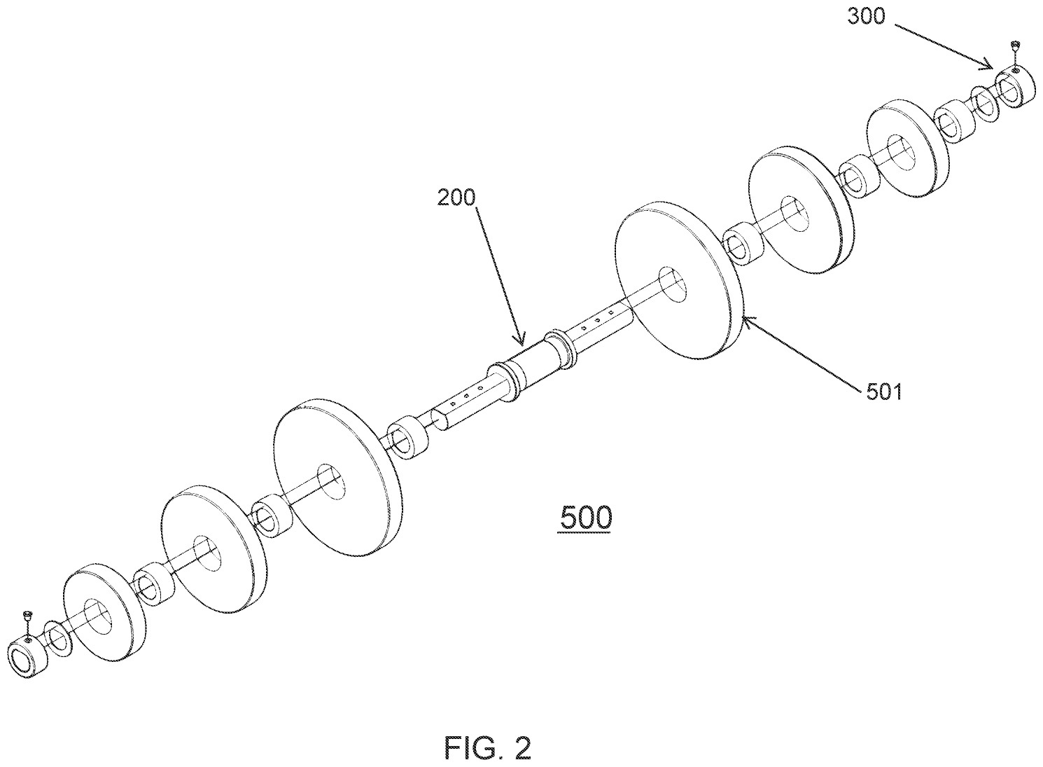

Once the locking device is locked in position, the exercise equipment (e.g., dumbbell, barbell, etc.) is ready for use by a user. FIG. 2 shows an exploded view of the exercise weight that was manufactured and assembled according to the method shown in the flowchart of FIG. 1, which will be discussed in more detail below. The locking device provides sufficient compressive force onto the handlebar in order to secure the weight plates in position. The weight plates provide an improved functional and aesthetic exercise equipment, which is also safely secured by the improved locking device for the increased safety of the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

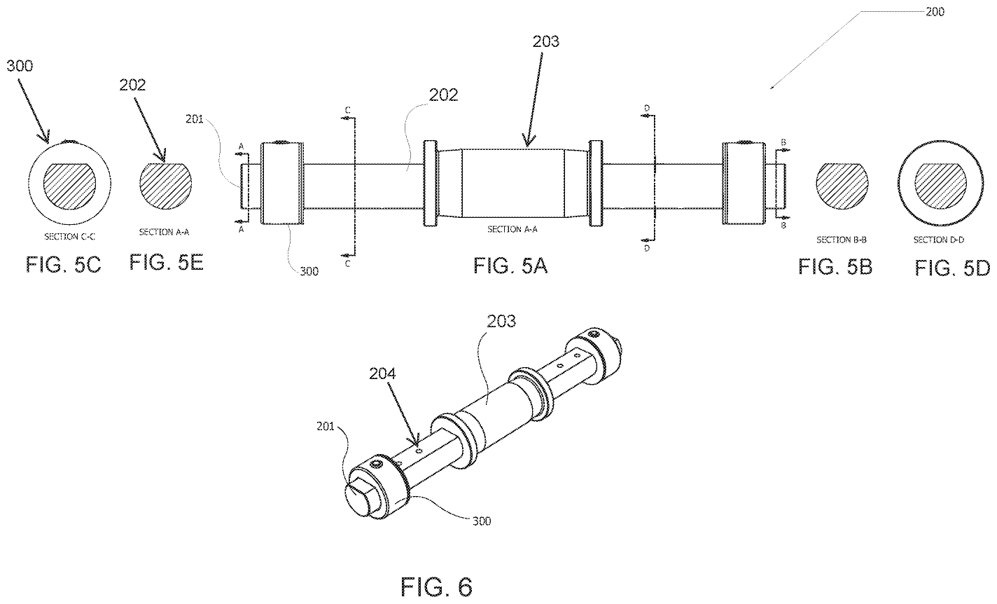

FIGS. 2 and 5A-5E illustrate a handlebar 200 according to one or more embodiments. As illustrated, the handlebar 200 is formed of a bar 201. The bar 201 may be manufactured of any suitable material including, without limitation, metal, natural stone, plastic, or wood. In addition, the different portions of the handlebar may be formed of different materials, such that the handlebar is formed of a combination of metal, natural stone, plastic, wood, or the like.

As shown in FIG. 5A, the bar 201 has a center portion 203 in a middle region to accommodate a hand of the user. The bar 201 also has two end portions 202 located on either side of the center portion 203. Each end portion 202 is designed to accommodate one or more exercise plates 500, which includes one or more weight plates 501. The exercise plates 500 will be described in more detail below.

As shown in FIGS. 5B-5E, each end portion 202 has a truncated cross-section with a flattened portion that is machined off to create a “D” shaped cross-section when viewed along a central axis of the handlebar 200 from one end. Each end portion 202 has the same shape. The flat portion of the end portion 202 includes one or more holes 204, as illustrated in FIG. 6.

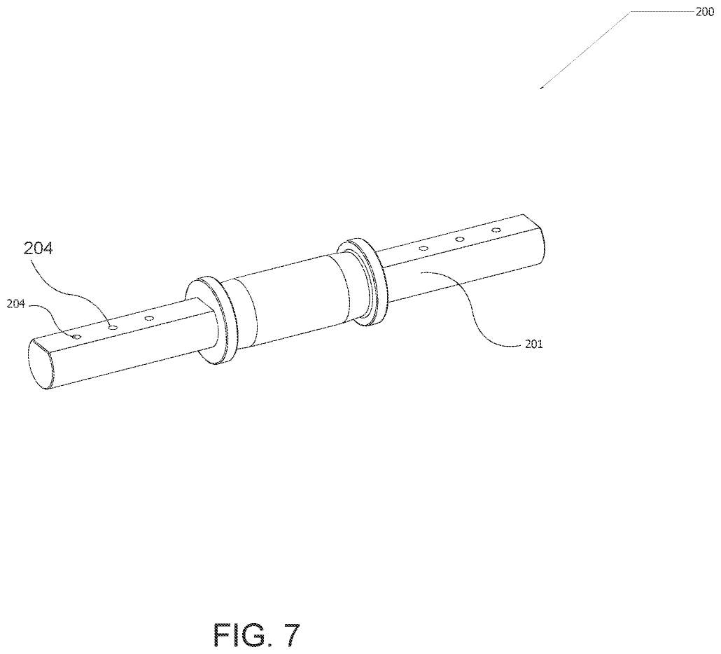

As shown in FIG. 7, the holes 204 are machined at a predetermined spacing to accommodate one, two, three, or more weight plates 501. The spacing between the holes 204 is determined based on the thickness of the weight plates 501 to be placed on the handlebar 200. The spacing between the holes 204 may be uniform or the spacing between each hole 204 may be different. The holes 204 may extend partially through or entirely through the diameter or width of the end portion 202 of the handlebar 200. For holes 204 that extend only partially through the end portion 202, a bottom of the holes 204 may be flat, angled, concave, convex, or the like.

As illustrated in the FIGS. 2 and 6, each hole 204 is configured to be spaced so as to accommodate at least one weight plate 501 between the locking device 300 and the stop member or division position between the end portion 202 and the center portion 203. By virtue of this configuration, the user loads a desired number of pairs of weight plates 500 to achieve the desired combined weight, which includes the total weight of the weight plates 500 and the weight of the handlebar 200.

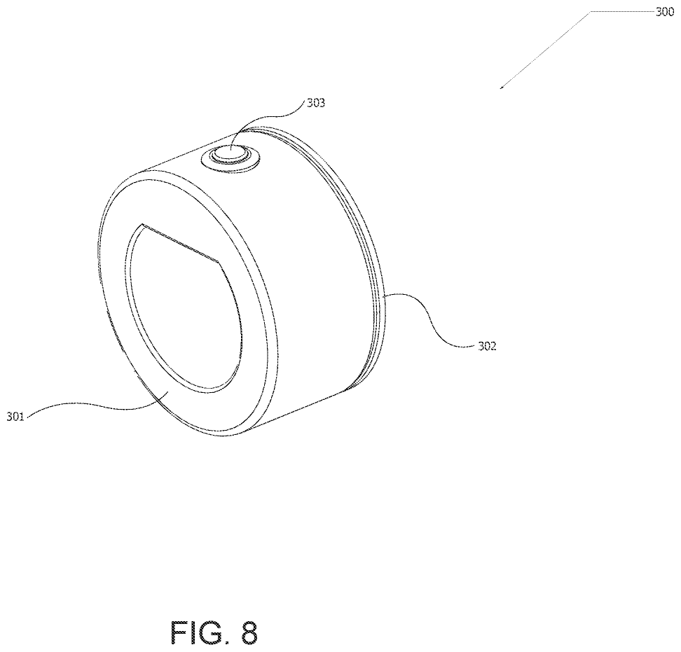

An exemplary embodiment of the locking device (also referred to as a collar) 300 is illustrated in FIG. 8. The locking device 300 has a truncated ring-like or annular shaped structure that allows the user to slide the locking device or the collar 300 onto the “D” shaped end portion 202 of the handlebar 200. The locking device or the collar 300 has an internal shape that corresponds to the “D” shaped end portion 202 so that the complementary shapes form a tight/snug fit. The locking device or the collar 300 includes a metal ring 301 designed to snug fit onto the end portion 202 of the handlebar 200. The inside shape of the collar or locking device 300 has a D shape so as to mate in a snug fit onto the end portion 202 of the handlebar 200.

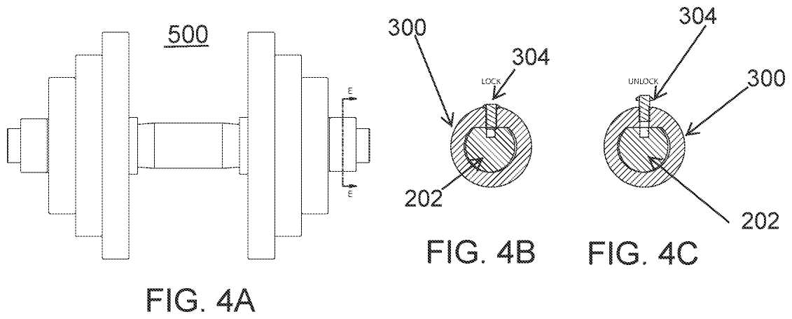

FIGS. 4B and 4C are cross-sectional views of an exercise weight 500, as shown in FIG. 4A. FIGS. 4B and 4C illustrate the locking device or the collar 300 also includes a spring-loaded pin 304 that is lifted to be in a disengaged position by the user depressing on a push button 303. The push button 303 is located on an outer surface of the locking device or the collar 300 for ease of access for the user. The spring-loaded pin 304 is formed of a spring-loaded lever piece (not illustrated) that allows the user to push down on the push button 303, which effectuates an opposite movement (upward) of the spring-loaded pin 304.

Once the spring-loaded pin 304 is lifted, the locking device or the collar 300 may be slid onto the handlebar 200, so that the complementary shapes of the end portion 202 and the locking device or the collar 300 are fitted together. While sliding the locking device or the collar 300 onto the end portion 202, the user continues to hold down the push button 303 so that the spring-loaded pin 304 remains in a retracted or disengaged state. FIG. 4C shows a disengaged or unlocked state of the spring-loaded pin 304, and FIG. 4B shows an engaged or locked state of the spring-loaded pin 304. The user slides the locking device or the collar 300 along the end portion 202 until an outer axial surface 302 of the locking device or the collar 300 abuts against the outermost weight plate 501 and releases the push button 303. By releasing the push button 303, the spring-loaded pin 304 is biased by an internal spring, and enters the flat-bottom hole 205, as illustrated in FIG. 4B, in a secure, tight fit to be in an engaged state (locked position). In the engaged state (locked position), the spring-loaded pin 304 causes the locking device or the collar 300 to lock the weight plate(s) 501 into position and secure the weight plates(s) 501 onto the handlebar 200. This process is repeated on the other end portion 202 of the handlebar 200 so that two locking devices or collars are locking the respective weight plate(s) 501 onto each respective end portion 202 of the handlebar 200.

A skilled artisan will understand that the pin 304 may be biased by any suitable biasing mechanism, which includes, but is not limited to, a spring, piston, lever, pressurized vessel, or the like.

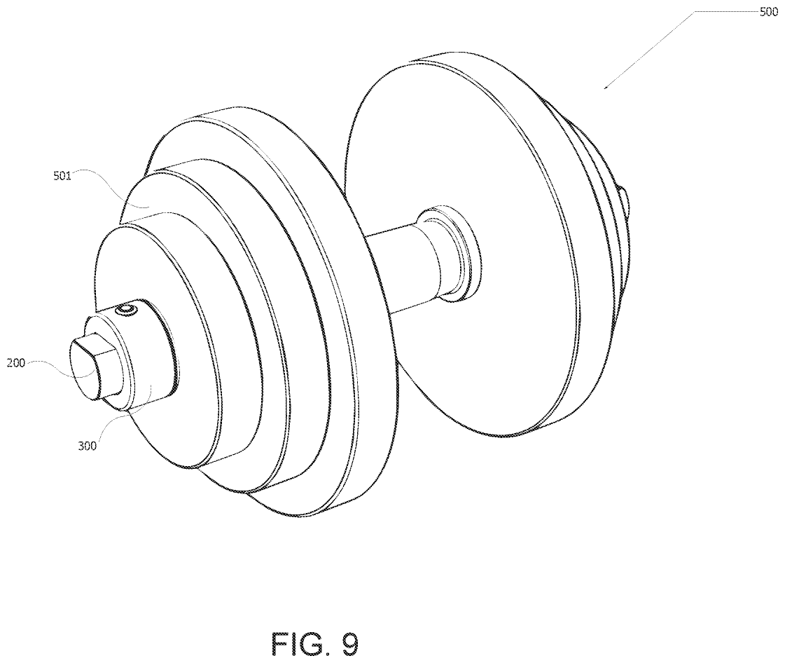

FIG. 9 is a perspective view of the exercise weight 500 according to one or more embodiments. The exercise weight 500 is manufactured according to the method illustrated in the FIG. 1. The exercise weight 500 includes the weight plate 501, the handlebar 200, and the collar device 300.

The exercise weight may include a one or a plurality of weight plates 501 and the handlebar 200 fashioned to hold the one or more weight plates using the locking device or collar 300. The assembled exercise weight may form, for example, a dumbbell, barbell, kettlebell, or similar adjustable or fixed weight equipment for exercise.

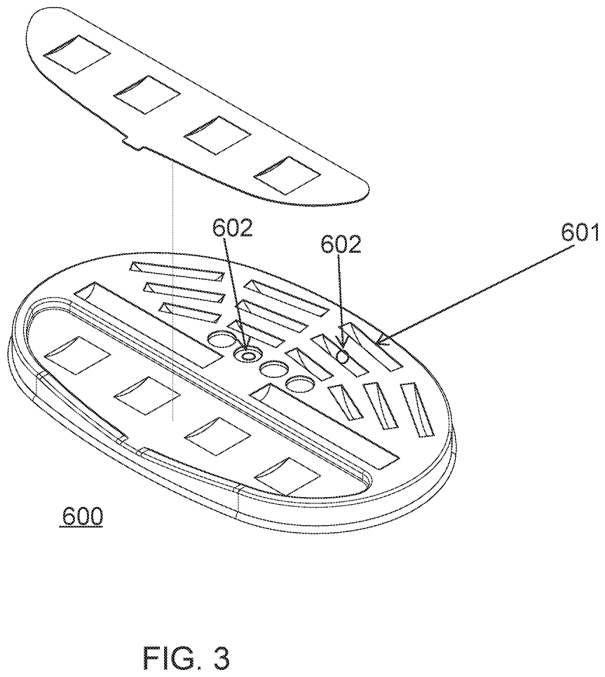

FIG. 3 is a perspective view of an exemplary storage device 600 according to one or more embodiments. The storage device 600 is a planar container that is formed of a substrate or similar board. The storage device 600 may be formed of a material of solid or laminated wood, plastic, metal, stone, or the like, or a combination thereof. The exemplary present embodiment of the storage device 600 is formed of wood.

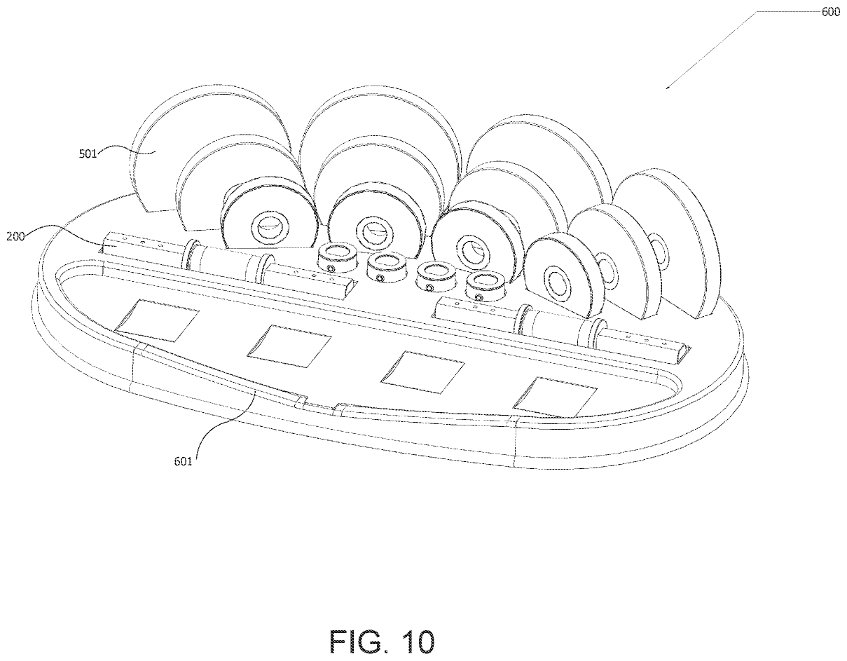

The storage device 600 includes a plurality of slots and/or recesses 601 that have dimensions that are complementary to a diameter and thickness of the weight plates 501, the handlebar 200, and the locking device or collar 300. The plurality of slots and/or recesses 601 each have a corresponding shape to one of the weight plates 501, the handlebar 200, or one locking device or collar 300, as shown in FIG. 10. For a slot and/or recess 601 to store a single weight plate 501, the slot and/or recess 601 has a depth such that the weight plate 501 stands upright on a circumferential surface of the weight plate 501. This configuration allows for more compact storage of the weight plate 501.

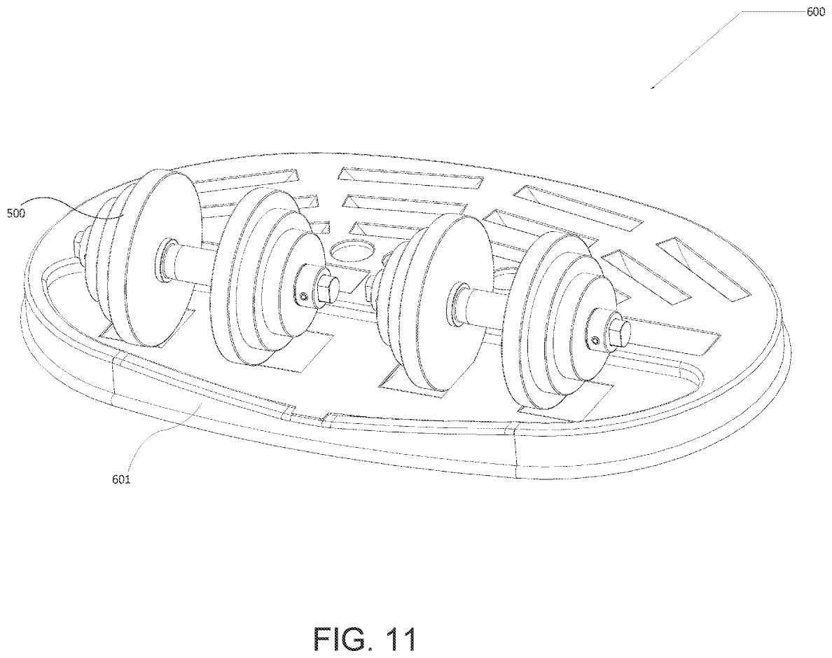

FIG. 11 illustrates that one or more of the plurality of slots and/or recesses 601 may be dimensioned to receive and store the assembled exercise weight 500. A bottom surface of the plurality of slots and/or recesses 601 may be flat, concave, or a same or similar corresponding shape as the shape of the weight plates 501, the handlebar 200, or one locking device or collar 300.

FIG. 3 illustrates that the storage device 600 includes at least one (or more) light source 602 located in one or more of the plurality of slots and/or recesses 601. Each light source 602 is located in the bottom surface of the slot and/or recess 601, such that the light source 602 acts as uplighting. In addition, or alternatively, the light source 602 is located in a side wall of the slot and/or recess 601. The light course 602 may emit white light or colored light. The light source 602 may also emitted multiple colors of visible light. Alternatively, the light source 602 may be located at any position on the storage device 600 and positioned to emit or direct light rays onto one or more of the weight plates 501, the handlebar 200, or the locking device or collar 300.

The storage device 600 may be mounted on a piece of furniture or a stand (not shown), which may be made of any suitable material. The storage device 600 may also include one or more handles (not shown) for transporting the storage device 600 and any exercise equipment 500 stored on the storage device 600. The storage device 600 may also include a cushion layer and/or non-slip layer located in one or more of the plurality of slots and/or recesses 601.

The benefits, advantages, solutions to problems, and any element(s) that may cause any benefit, advantage, or solution to occur or become more pronounced are not to be construed as a critical, required, or essential feature or element of any or all the claims.

Moreover, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. A device or structure that is “configured” in a certain way is configured in at least that way, but may also be configured in ways that are not listed.

1. A method of manufacturing a fixed or variable load exercise weight from a natural stone material, the method comprising:
cutting the natural stone material into a plurality of plates, each plate of the plurality of plates having a center hole;
assembling a handlebar and the plurality of plates by inserting the handlebar into the respective center hole of one or more plates of the plurality of plates, such that the handlebar holds the one or more plates on each respective end of the handlebar; and
sliding a locking device onto each end of the handlebar to lock the plates onto the handlebar, the locking device surrounds a circumference of the handlebar.

2. The method of manufacturing according to claim 1, wherein the handlebar further includes a plurality of flat-bottomed holes spaced apart from each other along an a central axis of the handlebar in an axial direction, a distance between each of the plurality of holes being set based on a thickness of one or more of the plurality of plates.

3. The method of manufacturing according to claim 1, wherein the handlebar is formed of a center portion and two end portions located on each side of the center portion in the axial direction, each end portion having a D shaped cross-sectional shape when viewed from the respective end.

4. The method of manufacturing according to claim 1, wherein an inner shape of the locking device has a D shaped cross-sectional shape so as to be complementary with the shape of each end portion of the handlebar, which creates a snug fit onto the handlebar.

5. The method of manufacturing according to claim 1, wherein the locking device further includes a spring-loaded pin and a push button, the spring-loaded pin being configured to be retracted by depressing on the push button.

6. The method of manufacturing according to claim 1, wherein the natural stone material is selected from a group of granite, marble, quartzite, rocks, schist, engineered stone quartz, glass, or amalgams of concrete with the glass, the granite, or the marble.

7. The method of manufacturing according to claim 1, wherein the cutting of the natural stone material into the plurality of plates is performed using a water-jet or a computer-controlled cutting machine.

8. The method of manufacturing according to claim 1, the handlebar is formed from a material selected from a group of metal, natural stone, plastic, or wood.

9. An storage device for storing the manufactured fixed or variable load exercise weight according to the method of claim 1, the device comprising:
a board formed of wood material; and
a plurality of slots having a complementary diameter and thickness corresponding to shapes of the plurality of plates, the handlebar, and the locking device.

10. The device according to claim 9, wherein the device is mounted on a piece of furniture or a table.

11. The device according to claim 9, further comprising a light source located in at least one of the plurality of slots, the light source being configured to emit light onto at least one of the plurality of weight plates when the at least one weight plate is stored in the at least one slot of the plurality of slots.

12. An exercise weight system comprising:
a plurality of plates formed of a natural stone material, the plurality of plates each having a center hole;
a handlebar having a center portion located between two end portions, the center portion being configured to be gripped by a user, each of the end portions being configured to be inserted into the center hole of at least one of the plurality of plates, each of the end portions including at least one locking hole extending at least partially through the end portion in a direction perpendicular to a central axis of the handlebar; and
a plurality of locking devices including an opening in a respective center portion, each locking device being configured to be inserted over one end portion of the handlebar such that the respective end portion passes through the opening, each locking device including a biased pin configured to be retracted and extended relative to the opening, the biased pin being configured to be extended and inserted into the at least one locking hole when the respective locking device is positioned onto the end portion of the handlebar in order to secure the at least one plate of the plurality of plates onto the handlebar.
